(19) United States
(12) Patent Application Publication
(10) Pub. No.: US 2024/0118803 A1
(43) Pub. Date: Apr. 11, 2024

(54) SYSTEM AND METHOD OF GENERATING DIGITAL INK NOTES

(71) Applicant: Microsoft Technology Licensing, LLC, Redmond, WA (US)

(72) Inventors: Fnu PRIMADONA, Mill Creek, WA (US); Sivaramakrishna MOPATI, Issaquah, WA (US); Jason Glenn SILVIS, Snohomish, WA (US)

(73) Assignee: Microsoft Technology Licensing, LLC, Redmond, WA (US)

(21) Appl. No.: 17/962,256

(22) Filed: Oct. 7, 2022

(51) Int. Cl. G06F 3/04883; G06F 3/04845; G06F 11/34

(52) U.S. Cl. CPC G06F 3/04883; G06F 3/04845; G06F 11/3438

(57) ABSTRACT

A method of and system for automatically generating an ink note object is carried out by detecting receipt of a digital ink input on a user interface (UI) screen, the UI screen being displayed by an application and being associated with at least one of a document, a page or an event. Once digital ink input is detected, the digital ink input is captured. Additionally, contextual data associated with the digital ink input is collected, the contextual data being related to at least one of the document, the page, the event, and a user providing the digital ink input. An ink note object is then generated and stored for the digital ink input, the ink note object including the captured digital ink input and the contextual data, and the ink note object being an entity that is separate from the document, the page and the even.

### BACKGROUND

Many recently developed computer devices have the ability to receive digital ink as a form of input. As a result, numerous users have begun utilizing digital ink input as a manner of interacting with a computer device. The digital ink input may take the form of handwritten strokes, which the device may display as ink as the strokes are entered. To receive the handwritten strokes, the device may provide a writing surface, which could be the same as the display screen. This enables the user to view the digital ink as the user is writing and/or drawing on the surface. A handwritten stroke may begin when a writing instrument lands on the writing surface and may end when the writing instrument is lifted off the writing surface. The writing instrument may be an electronic or non-electronic pen, a stylus, the user's own finger, or any another object used to write on the writing surface.

While using digital ink as a form of input may be beneficial in many situations, currently, digital ink can only be received if it is offered as a feature of the computer application the user is utilizing. Furthermore, the user is often required to choose specific application features (e.g., click on specific menu buttons or open specific user interface elements) to begin providing digital ink input. Additionally, the received ink input is often stored as part of the document the user is viewing or working on. Thus, other users reviewing the same document at a later time can see the received ink input. Furthermore, there are no easy mechanisms by which a user can review and/or retrieve their digital ink input. As a result, traditional mechanisms of capturing and retrieving digital ink input have many disadvantages.

Hence, there is a need for improved systems and methods for providing optimized digital ink use.

### SUMMARY

In one general aspect, the instant disclosure describes a device having one or more processors, and a memory in communication with the processors where the memory comprises executable instructions that, when executed by the processors, cause the device to perform multiple functions. The functions may include detecting receipt of a digital ink input on a user interface (UI) screen, the UI screen being displayed by an application and the UI screen being associated with at least one of a document, a page or an event, capturing the digital ink input, collecting contextual data associated with the digital ink input, the contextual data being related to at least one of the document, the page, the event, and a user providing the digital ink input, generating an ink note object for the digital ink input, the ink note object including the captured digital ink input and the contextual data, and storing the ink note object as an entity that is separate from the document, the page and the event.

In yet another general aspect, the instant disclosure describes a method for automatically generating an ink note object, where the method includes the steps of detecting receipt of a digital ink input on a UI screen, the UI screen being displayed by an application and being associated with at least one of a document, a page or an event. Once digital ink input is detected, the digital ink input is captured. Additionally, contextual data associated with the digital ink input is collected, the contextual data being related to at least one of the document, the page, the event, and a user providing the digital ink input. An ink note object is then generated and stored for the digital ink input, the ink note object including the captured digital ink input and the contextual data, and the ink note object being an entity that is separate from the document, the page and the even.

In a further general aspect, the instant disclosure describes a non-transitory computer readable medium on which are stored instructions that when executed cause a programmable device to detecting receipt of a digital ink input on a UI screen, the UI screen displayed content and the UI screen being associated with at least one of a document, a page or an event, capturing the digital ink input, collecting contextual data associated with the digital ink input, the contextual data being related to at least one of the content, the document, the page, the event, and a user providing the digital ink input, generating an ink note object for the digital ink input, the ink note object including the captured digital ink input and the contextual data, and storing the ink note object as an entity that is separate from the document, the underlying content, the page and the event.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an example system environment, upon which aspects of this disclosure may be implemented.

FIG. 2 depicts an example of some of the elements of an ink capture and retrieval engine upon which aspects of this disclosure may be implemented

FIGS. 3A-3C depicts example UI screens for providing digital ink input and displaying previously generated ink notes.

FIGS. 3A-3B depict an example UI screen for providing multiple paths for navigating a UI element using digital ink input.

FIGS. 4A-4B depict alternative example UI screens for providing digital ink input and displaying previously generated ink notes.

FIG. 5 is a flow diagram showing an example method for for capturing and retrieving a digital ink note.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

Digital ink has become popular in recent years as a form of input for many computer users. For example, users may utilize digital ink input in a similar manner as that of pen and paper to take notes during a meeting or while reviewing a document, draw a diagram, highlight a content portion, write a formula or perform various other tasks. However, to receive digital ink as an input, the computer application utilized by the user has to be an ink-enabled application. This significantly limits the user's ability to utilize digital ink as a note taking tool, while working with various computer applications, as many computer application do not have offer digital ink as a form of input. Thus, the user is not able to use digital ink to take notes directly on the user interface screen (e.g., surface) they are working on. Instead, the user may have to open an ink-enabled application and switch back and forth between the two applications to take notes. Furthermore, to ensure that the note can be later identified in association with the underlying document, UI screen or event, the user was working, additionally identifying information would need to be added to the note. For example, the user may need to enter the name of the document for which notes were being taken, the specific location on the document the note relates to, the location the document is stored at, and/or take a screenshot of the location on the document the note relates to. This would disrupt the user's workflow, lead to distraction and results in unnecessary waste of time and compute resources. Thus, there exits the technical problem of inability of current digital ink capturing mechanisms to capture digital ink notes on non-ink enabled applications. Furthermore, there exists another technical problem of inability of current digital ink capturing mechanisms to automatically capture contextual information about the note being taken.

Additionally, while some current ink-enabled applications provide a mechanism by which digital ink can be captured on top of a document, the digital ink in these application is captured and stored as part of the document. As a result, the next time the document is viewed (e.g., by the same user or a different user), the note will be displayed as part of the document. However, in many situations, the user may not have a desire to share their personal notes with other users and/or may not want to change the underlying document. In these situations, even if the document is offered by an ink-enabled application, the user may not be able to use digital ink to take notes for the document, unless they utilize a separate note-taking application, in which case, the note would need to be separately created and stored, resulting in disruption of workflow and inefficiency. Furthermore, when notes are taken and stored separately, the user would need to remember that they took a note in association with a document and remember where the note was stored to be able to retrieve the note. Thus, there exits another technical problem of inefficiency of current digital ink capturing and retrieving mechanisms in capturing and retrieving digital ink notes in association with ink-enabled applications.

To address these issues and more, in an example, this description provides a technical solution that enables use of a writing instrument to capture content provided via a digital ink stroke on any surface, and enables in-context retrieval of captured notes. In addition to the digital ink, the content is captured with appropriate context and stored as an ink note object that can be retrieved in relevant contexts. To achieve this, a mechanism may be used to detect a writing instrument gesture on a UI screen, capture the digital ink input provided, capture relevant context in association with the digital ink, and store the ink input and captured context as an ink note object. The relevant context may depend on the type of document, application, event, user and/or note taken. In some implementations, machine-learning (ML) models are used to infer the relevant context. The relevant context is stored as part of the ink note object and/or as metadata for the ink note object. Notes objects may be captured and stored automatically to make the note taking process more efficient. Furthermore, the technical solution retrieves stored ink notes automatically, in context, to enable easy access.

As will be understood by persons of skill in the art upon reading this disclosure, benefits and advantages provided by such implementations can include, but are not limited to, a solution to the technical problems of inability of current mechanisms to capture digital ink as notes on non-ink enabled applications and inability of current ink-enabled applications to store the digital ink as a separate note from the document on which the note is taken. Furthermore, the technical solutions address the technical problems of having inefficient, error-prone, time-consuming and difficult to use methods for capturing and retrieving digital ink notes. Technical solutions and implementations provided herein optimize and improve the process of capture and retrieval of digital ink notes. In this manner, the technical solutions minimize manual user input and improve the operation and efficiency of computer systems used in capturing, processing and retrieving ink notes. The technical effects at least include (1) expanding the ability of computer systems in capturing digital ink notes; (2) improving the efficiency of using computing systems to capture, store and retrieve digital ink notes; and (3) improving UI screens by enabling display of relevant stored ink notes in a location that is visible and accessible to users, while being separate from underlying UI application screens.

As used herein, the term “writing instrument” may refer to any device used to provide digital ink input. This may include an electronic or non-electronic pen, a stylus, or the user's own finger. Furthermore, as used herein, the term “digital ink” may be used to refer to any input received via a writing instrument. The term “ink note” may refer to a document or graphical object that captures the content of a digital ink note as well as contextual information related to the digital ink note.

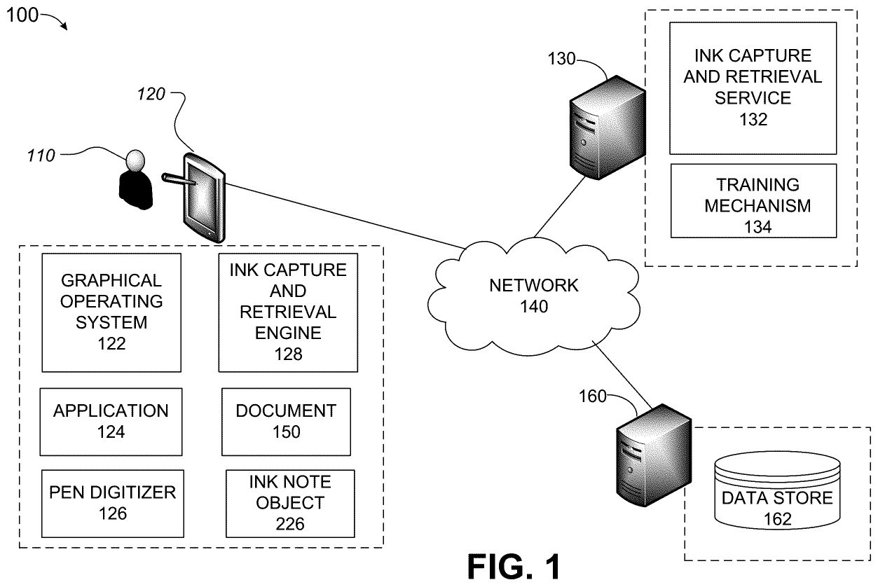

FIG. 1 illustrates an example system environment 100, upon which aspects of this disclosure may be implemented. In different implementations, the environment 100 includes a one or more computing device users, also referred to herein as users, such as a user 110, using a client device 120. Each user can utilize a writing instrument to enter digital ink input via their respective client device. The user 110 can provide the digital ink input while the client device 120 displays any UI screen (e.g., a UI of any application). For example, digital ink input may be provided by the user 110 while the client device 120 displays an active UI screen for an application 124. The application 124 may be a computer program executed on the client device 120 that configures the device to be responsive to user input to allow the user 110 to interactively view, generate and/or edit digital content. The application 124 can be either be an ink-enabled application or a non-ink enabled application. In an example, the application 124 is an application that enables a user to view, generate and/or edit digital content such as digital ink content within an electronic document 150. The application 124 processes the electronic document 150, in response to user input by displaying or otherwise presenting display data, such as a UI which includes the content of the electronic document 150, to the user 410. Examples of suitable applications include, but are not limited to, a word processing application, a presentation application, a note taking application, a text editing application, an email application, a spreadsheet application, an instant messaging application, a communications application, a web browser application, and multimedia player application, and the like. For example, the application 124 may be a web browser application that displays a webpage, and the user can provide digital ink input anywhere on the webpage displayed by the browser.

The electronic document 150 can be any electronic file accessible via the client device 120. The electronic document 150 and the term “document” used herein can be representative of any file that can be created via an application executing on a computer device. Examples of documents include, but are not limited to, word-processing documents, presentations, spreadsheets, notebooks, email messages, videos, images, and the like. The electronic document 150 may be stored locally on the client device 120, stored in the data store 162 or stored in a different data store and/or server.

Input from a writing instrument is received and processed via a pen digitizer 126. In some implementations, the pen digitizer is a layer of material (e.g., glass) positioned over a display screen of the client device 120. The pen digitizer 126 includes one or more sensors designed to detect movement on the screen. Once movement is detected, the pen digitizer 12 converts the analog touch input into digital signals. The digital signals may include position of the writing instrument and/or other properties about the touch input such as direction of stroke, timing, velocity, tilt and/or pressure. The digital signals that are collected or calculated by the pen digitizer 126 are then transmitted to a graphical operating system 122 (e.g., Microsoft® Windows) for further processing. In some implementations, the graphical operating system 122 transmits the digital signals to the ink capture and retrieval engine 128 for processing. The ink capture and retrieval engine 128 may be a part of the application 124 or a note taking application or may be a separate program running on the client device 120. The ink capture and retrieval engine 128 processes the digital signals to detect the presence of a digital ink note, identify a position on the UI screen of the application 124 for the digital ink input received, determine an association between the provided digital ink and the underlying content (e.g., content of the UI screen on which the digital ink is received), and collect data related to the digital ink input, the underlying document or application (e.g., application 124 or document 150) and/or the user 110. Depending on the digital ink input and the collected data, the ink capture and retrieval engine 128 determines whether an ink note should be generated and may process the data to generate contextual data for the ink note. The ink capture and ink retrieval service 132 then generates an ink note object for the received digital ink input and stores the contextual data long with the generated ink note object. The ink capture and retrieval engine 128 also monitors the user's use of application 124 and/or document 150 to identify contexts in which a stored ink note object should be retrieved and displayed.

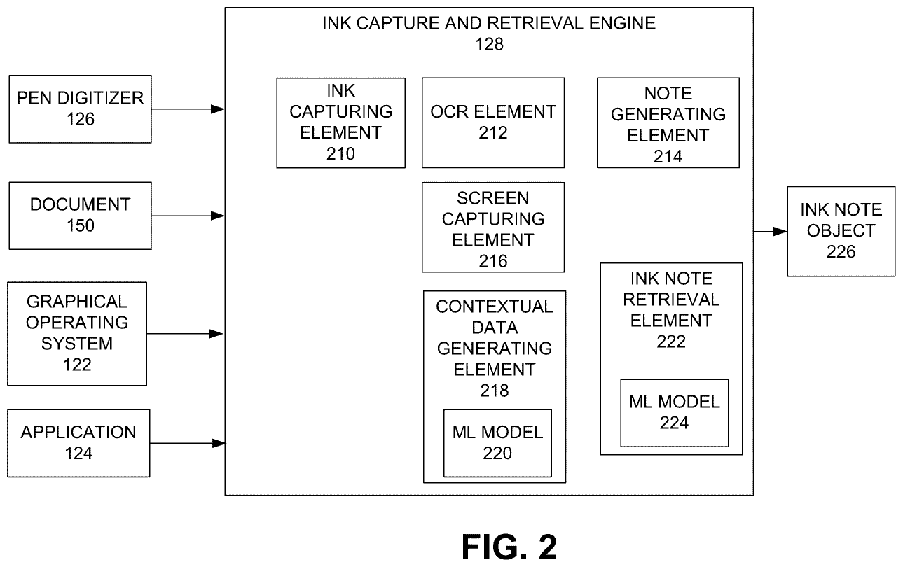

In some implementations, data relating to the entered digital ink (e.g., pen signals) and the data related to the underlying document or application (e.g., application 124 or document 150) and/or the user 110 is collected by the client device 120 and transmitted to a server 130 via one or more network(s) 140. The server 130 includes or is connected to a data store 162 which can be used to store the collected data. The server 130 also includes and/or is connected to an ink capture and retrieval service 132 for capturing a digital ink note, collecting and/or analyzing data in association with the ink note, creating an ink note and/or determining when to retrieve and display an already generated ink note. At least some of the actions performed by ink capture and retrieval service 132 and/or ink capture and retrieval engine 128 are achieved by utilizing one or more ML models, as discussed in greater detail with respect to FIG. 2.

One or more ML models implemented by the ink capture and retrieval service 132 and/or ink capture and retrieval engine 128 are trained by the training mechanism 134. The training mechanism 134 may use training data sets stored in the data store 162 to provide initial and ongoing training for each of the models. Alternatively, or additionally, the training mechanism 134 uses training datasets from elsewhere. In some implementations, the training mechanism 134 uses labeled training data to train one or more of the models via deep neural network(s) or other types of ML models. The initial training may be performed in an offline stage.

As a general matter, the methods and systems described herein may include, or otherwise make use of one or more ML model to analyze contextual data, determine a topic and/or a context in which an ink note is generated, and/or identifying situations in which a stored ink note should be retrieved and displayed. ML generally involves various algorithms that can automatically learn over time. The foundation of these algorithms is generally built on mathematics and statistics that can be employed to predict events, classify entities, diagnose problems, and model function approximations. As an example, a system can be trained using data generated by a ML model in order to identify patterns in documents, determine associations between various words, documents, events and ink notes, and determine when to display ink notes. Such training is made following the accumulation, review, and/or analysis of data over time. Such data is configured to provide the ML algorithm (MLA) with an initial or ongoing training set. In addition, in some implementations, a user device can be configured to transmit data captured locally during use of relevant application(s) to a local or remote ML algorithm and provide supplemental training data that can serve to fine-tune or increase the effectiveness of the MLA. The supplemental data can also be used to improve the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of both the initial and subsequent trained ML model is referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying MLAs, such as, but not limited to, decision trees, random decision forests, neural networks, deep learning (for example, convolutional neural networks), support vector machines, regression (for example, support vector regression, Bayesian linear regression, or Gaussian process regression) may be trained. As another example, size or complexity of a model is varied between different ML models, such as a maximum depth for decision trees, or a number and/or size of hidden layers in a convolutional neural network. Moreover, different training approaches may be used for training different ML models, such as, but not limited to, selection of training, validation, and test sets of training data, ordering and/or weighting of training data items, or numbers of training iterations. One or more of the resulting trained ML models may be selected based on factors such as, but not limited to, accuracy, computational efficiency, and/or power efficiency. In some implementations, a single trained ML model is produced.

The training data may be occasionally updated, and one or more of the ML models used by the system can be revised or regenerated to reflect the updates to the training data. Over time, the training system (whether stored remotely, locally, or both) can be configured to receive and accumulate more training data items, thereby increasing the amount and variety of training data available for ML model training, resulting in increased accuracy, effectiveness, and robustness of trained ML models.

In collecting, storing, using and/or displaying any user data used in training ML models or analyzing documents to generate titles, care is taken to comply with privacy guidelines and regulations. For example, options may be provided to seek consent (e.g., opt-in) from users for collection and use of user data, to enable users to opt-out of data collection, and/or to allow users to view and/or correct collected data.

The system 100 includes a server 160 which is connected to or includes the data store 162 which functions as a repository in which databases relating to training models, documents, contextual data, and/or ink notes can be stored. Although shown as a single data store, the data store 162 may be representative of multiple storage devices and data stores which are accessible by one or more of the ink capture and retrieval service 132, training mechanism 134, and/or client device 120.

The network 140 is a wired or wireless network or a combination of wired and wireless networks that connect one or more elements of the system 100. The network 140 may have numerous different configurations including a star configuration, token ring configuration, or other configurations. For instance, the network 140 may include one or more local area networks (LAN), wide area networks (WAN) (e.g., the Internet), public networks, private networks, virtual networks, mesh networks, peer-to-peer networks, and/or other interconnected data paths across which multiple devices may communicate. The network 140 may also be coupled to or include portions of a telecommunications network for sending data in a variety of different communication protocols. In one implementation, the network 140 includes Bluetooth® communication networks or a cellular communications network for sending and receiving data including via short messaging service (SMS), multimedia messaging service (MMS), hypertext transfer protocol (HTTP), direct data connection, WAP, email, and the like.

In some implementations, the server 130 is configured to perform one or more steps of the methods disclosed herein via for example the ink capture and retrieval service 132. Furthermore, the server 130 may include one or more online applications that may be accessed via the client device 120 and upon which digital ink input can be received and processed.

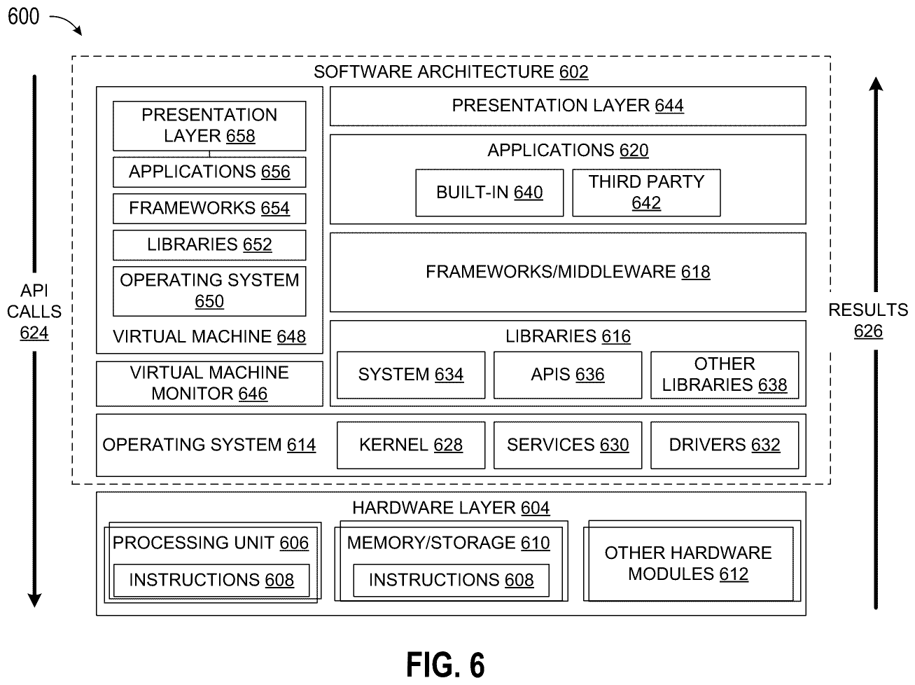

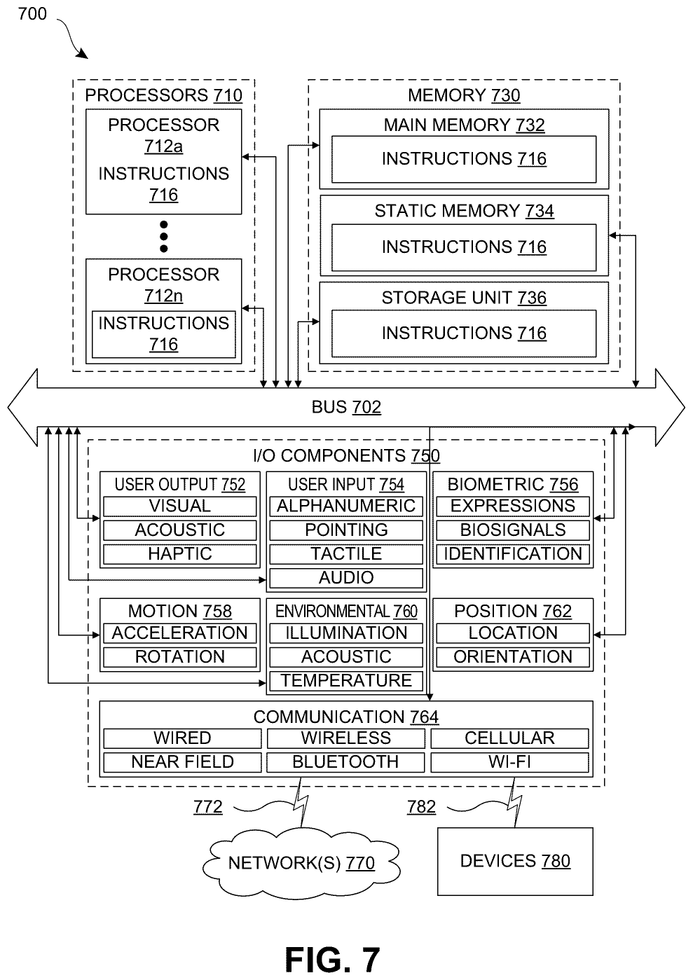

The client device 120 is representative of a plurality of client devices that may be present in the system. The client device 120 includes virtual or physical computer processors, memories, communication interface(s)/device(s), etc., which, along with other components of the client device 120, are coupled to the network 140 for communication with other entities of the system 100. For example, the client device 120, accessed by the user 110 sends and receives data (e.g., digital ink input and/or contextual data) to the server 130 and/or the server 160 for processing and/or storage. Each client device 120 is a type of personal, business or handheld computing device having or being connected to input/output elements that enable a user to interact with a writing instrument to provide digital ink input and view ink notes. Examples of suitable client devices 120 include but are not limited to personal computers, desktop computers, laptop computers, mobile telephones, smart phones, tablets, phablets, smart watches, wearable computers, gaming devices/computers, televisions; and the like. The internal hardware structure of a client device is discussed in greater detail with respect to FIGS. 6 and 7. It should be noted that although the client device 120 is shown as being connected to the network 140, it could be disconnected and operate independently from a network environment, at least temporarily. For example, the ink capture and retrieval engine 128 may be used to perform all operations relating to processing ink input and generating and retrieving ink notes for the client device 120.

FIG. 2 depicts an example of some of the elements of an ink capture and retrieval engine upon which aspects of this disclosure may be implemented. In some implementations, the ink capture and retrieval engine 128 includes an ink capturing element 210, OCR element 212, note generating element 214, screen capturing element 216, contextual data retrieval element 218 and ink note retrieval element 222. Data from the pen digitizer 126, document 150, graphical operating system 122 and/or application 124 is transmitted to the ink capture and retrieval engine 128 for processing.

In some implementations, upon detecting digital ink input from a writing instrument, data relating to the input is transmitted directly form the pen digitizer to the ink capture and retrieval engine 128. In alternative implementations, upon detecting digital ink input from a writing instrument, data related to the digital ink input is transmitted to the graphical operating system 122, which in turn transmits the data to the ink capture and retrieval engine 128. In some implementations, the graphical operating system 122 performs some pre-processing on the digital ink input before transmitting the data to the ink capture and retrieval engine 128. Furthermore, in some implementations, data related to the digital ink input is transmitted to the ink capture and retrieval engine 128 once a determination is made that entering digital ink input has been completed for a given ink note (e.g., once the writing instrument is lifted off of the screen for a predetermined amount of time). In some implementations, processing an entered digital ink input as an ink note occurs once a user request is received. For example, the user may transmit a request (e.g., via a gesture or by invoking a menu option) to process an entered digital ink as an ink note. Alternatively and/or additionally, processing a digital ink input as an ink note occurs automatically upon detection of digital ink input.

Once digital ink input is detected and a determination is made to process the entered digital ink input as an ink note, data relating to the digital ink input is transmitted to the to the ink capture and retrieval engine 128. The ink capture and retrieval engine 128 may then retrieve data related to the document 150 upon which the digital ink input was entered and/or data related to the application 124 which displayed the document 150 or which displayed a UI screen on which the digital ink input was entered. The data may include a portion of the document or UI screen on which the digital ink input was entered (e.g., the text of the document, an image of the UI screen or document page, etc.). The data may also include the name of the document 150 and/or application 124, a location at which the document 150 is stored or is otherwise accessible (e.g., a URL for a webpage), data about the type of document or application for which digital ink was entered, data about an event associated with the digital ink input (e.g., ink input was received on a presentation slide presented during an online meeting), and/or data about the user providing the digital ink input. Data about an event associated with the digital ink input may include the users associated with the event (e.g., participants in the meeting), the type of event (e.g., online meeting about a particular topic), date/time of the event and the like. Data about the user may include user history data about the user such as the user's prior ink notes, how and when the user generates ink notes and how and when the user uses previously generated ink notes. The retrieved data is then used by the ink capture and retrieval engine 128 to generate contextual data which can be stored with an ink note object, as discussed in more detail below.

In some implementations, the digital ink input is provided to the ink capturing element 210. The ink capturing element 210 may receive and process the digital ink input as an ink note. For example, the ink capturing element 210 receives the digital ink input and determines the type of ink input received to capture an image of the digital ink input. The type of ink received includes a writing (e.g., entered characters), a drawing, which may include circling an item, or highlighting. Depending on the type of ink input, the ink capturing element 210 can determine whether the underlying content should be included as part of the ink note. For example, when the ink type is circling or highlighting a portion of the underlying content, the ink capturing element 210 determines that the underlying content should be captured as part of the note. However, when the ink type is a writing, then the writing may be captured separately from the underlying content.

When the digital ink input includes characters, the ink capture and retrieval engine 128 makes use of an optical character recognition (OCR) element 212 to recognize the characters. This may be done to enable conversion of the entered ink input to text such that the ink note generated can include both the text and/or an image of the digital ink input. When the underlying content upon which digital ink input is entered is important (e.g., when the ink input is highlighting, circling or making a mark on the underlying content), and/or to ensure that context of the ink note is captured, the screen capturing element 216 is utilized to capture an image of the underlying content. The image may be of the entire UI screen or of a portion of the UI screen on which the digital ink input was entered. In some implementations, the image is of just the underlying content (e.g., without the digital ink input). In other implementations, the image is of the underlying content with the entered digital ink input to show the relationship between the entered ink input and the underlying content.

The ink capture and retrieval engine 128 also makes use of the contextual data generating element 218 to generate contextual data associated with the entered digital ink input. The contextual data is retrieved from the data received from the document 150, application 124 and/or the user entering the digital ink input. The received data is then processed by the contextual data generating element 218 to generate some contextual data that is relevant and/or likely to be useful with the ink note. To determine the type of contextual data that should be generated and stored with a given ink note, the contextual data generating element 218 makes use of one or more ML models 220. The ML models may include models that examine the user's prior history of ink notes and/or other user's prior history of ink notes to determine the type of contextual data useful for the type of digital ink input received. This may be achieved by examining parameters such as the type of document on which the digital ink input was received, the type of application, the type of digital ink input, an event associated with the digital ink input and the like. In some implementations, the contextual data generating element 218 (e.g., ML models 220) derive additional contextual data from a detected entity type or subject matter associated with the page or document on which the digital ink is entered. For example, if the user circles the cost of a car on car purchase website, the website URL, the detected subject matter (e.g., cars), and a detect intent of purchasing a car is derived and/or collected as contextual data. Further information may also be derived from additional knowledge source. For example, based on the types of cars displayed on the car and/or circled, the contextual data generating element 218 may determine, using a knowledge source or additional ML models, that the user is interested in sport cars. In another example, the make and model of the car the user is interested in is also determined. Based on the derived make and model, a link to the car manufacturer's website may also be identified. The derived or collected data may then stored as metadata with the captured ink note.

The captured ink, OCRed characters, captured screen image, and/or generated contextual data are then transmitted to the note generating element 214 for generating an ink note object for the digital ink input. The note generating element 214 then generates an ink note object 226 based on all of the received data. The ink note object 226 may be a note document that includes text characters, one or more images (e.g., an image of the digital ink input and an image of the underlying content) and/or contextual data. In some implementations, the contextual data is stored as metadata for the ink note object. In other implementations, the contextual data is stored as additional information within the ink note object. For example, upon opening an ink note object, in addition to an image of the ink input, data related to the document on which the digital ink input was entered is displayed (e.g., the name of the document, the location at which the document is stored and/or the page number of the document on which the digital ink input was entered). In another example, when the ink note relates to an event, data related to the event is included within the ink note (e.g., the name of the participants in the event, the date/time of the event, the event name, and the like).

The generated ink note object 226 is then provided as an output for storage. In some implementations, the ink note object 226 is automatically stored locally or remotely. For example, the ink note object may be stored in a folder on the client device designated for storing ink notes. This may be done to avoid disrupting the user's workflow and ensure the user's work is stored for future use and retrieval. Alternatively, the user may be provided an option (e.g., via a pop-up menu option) to store the generated ink note object 226.

The ink capture and retrieval engine 128 also includes the ink note retrieval element 222 for automatic retrieval of ink notes. The ink note retrieval element 222 may be used to recall ink notes, when a determination is made that a previously stored ink note object is related to an action the user is currently performing. This is achieved by receiving data about the current applications running on the client device, the current documents being utilized and/or the current task being performed. This data may be received from the graphical operating system 122 and/or active applications 124. The ink note retrieval element 222 can then analyze the received data to determine if the current context corresponds with a previously stored ink note object. This may be achieved by comparing contextual data about the current activities with contextual data of previously stored ink note objects to identify ink notes that correspond with current activities. For example, if the user opens a document on which they previously took a note, the ink note retrieval element 222 determines that the previously taken note relates to the document and retrieves the ink note object for display to the user. In another example, when the user begins an online meeting with the same group of participants and/or related to a same topic as a previous meeting for which an ink note was generated, the ink note retrieval element 222 identifies the association and retrieves the previously generated ink note. Other examples include determining that the user is at a geographical location (e.g., a grocery store) at which the user previously was located when they generated a previous ink note or that the user is visiting a website on which the user previously took a note. To determine the proper context for which a previously generated ink note should be retrieved, the ink note retrieval element 222 may make use of one or more ML models 224. The ML models 224 may be trained by using user history data relating to users' use of ink notes in different contexts.

It should be noted that while FIG. 2 depicts the ink capture and retrieval engine 128 as including the ink capturing element 210, OCR element 212, note generating element 214, screen capturing element 216, contextual data retrieval element 218 and ink note retrieval element 222, one or more of these elements may be included in the ink capture and retrieval service 132 of FIG. 1. For example, the ML models 220 and/or ML models 224 may be too large to store locally and as such may be provided as part of the ink capture and retrieval service 132. In other implementations, a light versions of the ML models 220 and/or ML models 224 is provided locally, while more complex versions are made available via the ink capture and retrieval service 132.

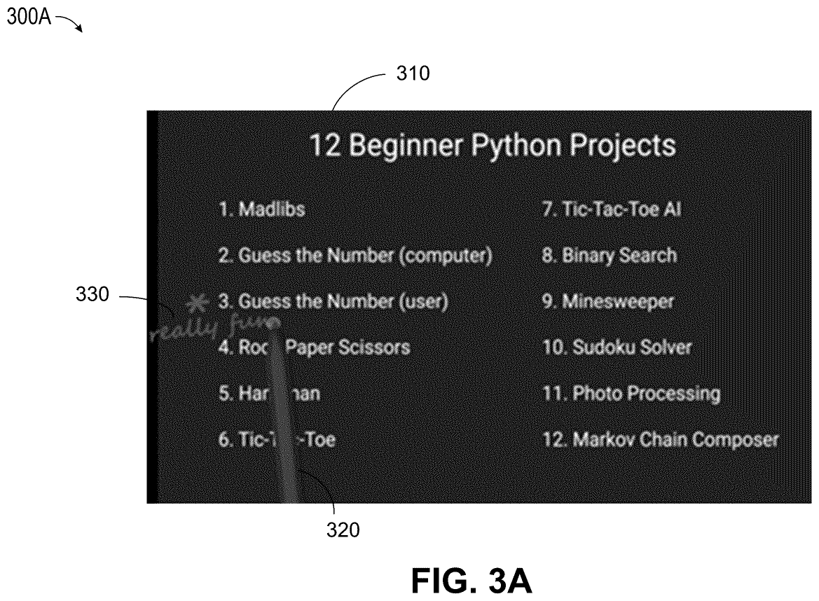

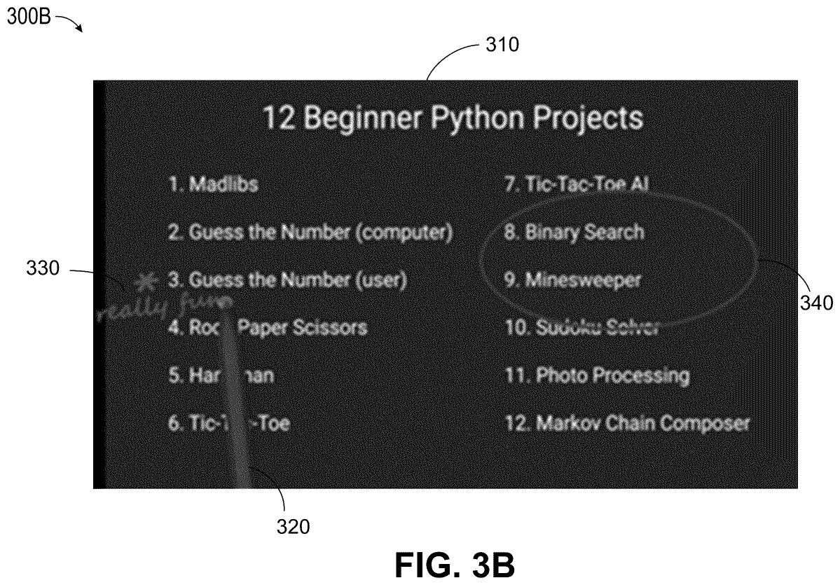

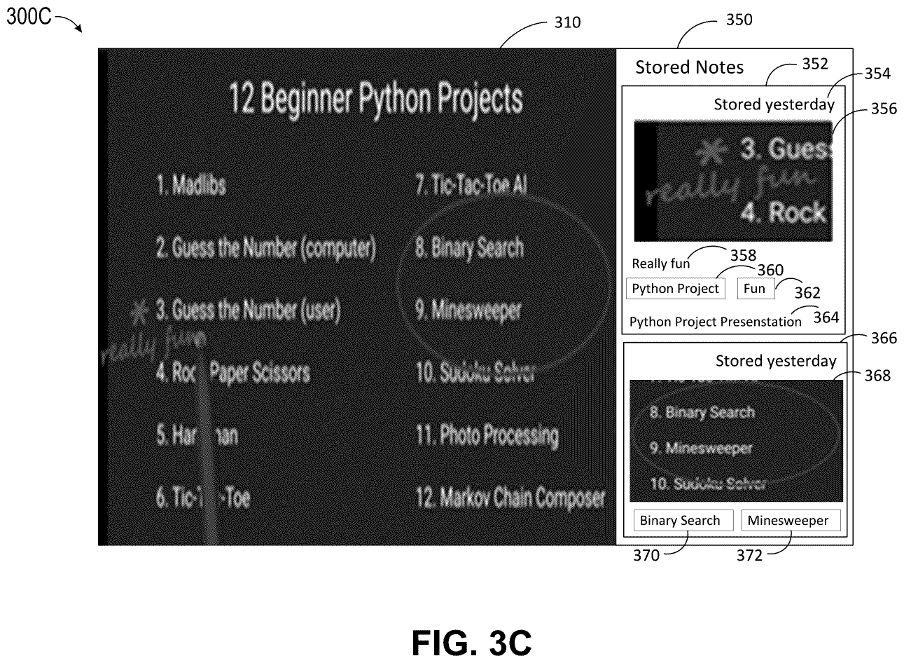

FIGS. 3A-3C depicts example UI screens for providing digital ink input and displaying previously generated ink notes. FIG. 3A depicts a UI screen 300A of a presentation application displaying a presentation slide 310 on which a digital ink input 330 is entered by utilizing a writing instrument 320. In some implementations, use of digital ink input is initiated by selecting one or more UI elements (e.g., menu options). In other implementations, the user begins providing digital ink input by simply starting to utilize a writing instrument such as the writing instrument 320. The digital ink input may be in the form of handwritten text, drawings, mathematic formulas or any other writing stroke on the UI screen via a writing instrument. For example, as shown on the UI screen 300A, the writing instrument 320 may be used to provide handwritten text such as the digital ink input 330. The writing surface may be provided on the same device that is displaying the UI screen. For example, the UI screen 300A may be a touch-enabled screen upon which the user can write using a writing instrument.

As depicted, the digital ink input 320 includes text characters that make up one or more words and/or other drawings. The digital ink input 320 is entered in relation to a specific content of the presentation slide 310. As such, the portion of the digital ink input 320 (e.g., item #3 on the presentation slide 310) may be associated with the digital ink input 320, when generating an ink note for the digital ink input 320. The application displaying the presentation slide 320 may be an ink-enabled application, such as a presentation application, or it may be a non-ink enabled application such as a communications application for conducting an online meeting. In an example, the presentation slide 310 is displayed during an online meeting. In another example, the presentation slide 310 is displayed as part of a video the user is watching on a website. In such examples, the presentation slide 310 may simply be displayed on the user's screen for a short period of time and may not be stored on the user's client device. However, the user is still able to enter digital ink input on the presentation slide 310 and generate an ink note related to the presentation slide and/or meeting or video, which may be later accessible. Once the digital ink input 330 detected and/or a determination is made that the ink input relates to an ink note, the digital ink input 330 as well as data relating to the presentation slide 330 is collected and processed to generate and store an ink note. In some implementations, the portion of the presentation slide 310 associated with the digital ink input 320 is captured and stored as part of the ink note for future reference. In some implementations, the entire content of the presentation slide 310 is captured and stored with the ink note.

FIG. 3B depicts a UI screen 300B of the presentation slide 310 on which a second digital ink input 340 is entered by utilizing the writing instrument 320. The digital ink input 340 is identified as being related to a separate ink note, since it is entered in a different part of the presentation slide 310. Furthermore, the digital ink input 340 may be considered as being related to a separate note because it is entered at a different time than the digital ink input 330 and/or because it is a different type of ink input (e.g., digital ink input 330 includes text, while digital ink input 340 is circling the underlying content). Once a determination is made that a different digital ink input has been received on the presentation slide 310 and that an ink note should be generated for the digital ink input 340, the digital ink input 340 (e.g., the drawing), the underlying content associated with the digital ink input 340 (e.g., item numbers #8 and 9 on the presentation slide 310) as well as information about the presentation slide 310 and the application displaying the presentation slide 310 is collected and transmitted to an ink capture and retrieval system for processing and creation of an ink note. In some implementations, since the digital ink input 340 is captured and stored as part of the same ink note that stored the digital ink input 330. The determination of how and when to generate separate ink notes for digital ink input on the same UI screen is made based on a variety of factors including the proximity of the digital ink inputs, the type of digital ink inputs, the period of time in between the digital ink inputs, and/or the user's prior history of creating ink notes.

In some implementations, when an ink note has been generated, a notification is displayed to the user (e.g., on the UI screens 300A-300B) that informs the user that an ink for the received digital ink input has been generated and requests confirmation for storage of the ink note. The notification may enable the user to view and/or edit the ink note, and/or choose where to store the ink note. The notification may also allow the user to combine two or more ink notes and/or split an ink note into two or more ink notes.

After the ink notes have been generated, an application or service running in the background monitors the current activities being performed by a user or on a given client device to determine when to retrieve a stored ink note object. In some implementations, the stored ink notes objects identified as being relevant to a current UI screen or document are displayed on a notes UI element, as depicted in UI screen 300C of FIG. 3C. For example, when the presentation slide 310 is displayed at a later time by a presentation application or as part of a meeting or video file, information about the presentation slide 310 is transmitted to the ink retrieval engine or service, which identifies the slide as being a document for which a note was generated. The stored notes are then displayed on the notes UI element 350, which is displayed on a side of the UI screen 300C. The notes UI element may be a UI panel that is automatically displayed, when a determination is made that a previously stored ink note should be retrieved. Alternatively, the notes UI element 350 is displayed when a notification is provided to the user that previously stored ink notes may be relevant to the current content and receiving confirmation from the user that the stored ink notes should be displayed. In another implementation, the UI element 350 is always displayed on the UI screen and/or can be toggled on and off, as desired.

In some implementations, the UI element 350 displays one or more ink note objects that it determines are related to the current application, content or event. The ink note objects may be sorted and displayed in an order of their relevance to the current content, application or event. Alternatively, the ink note objects are displayed chronologically with the most recent ink notes being displayed at the top. The UI element 350 includes an ink note UI element 354 and an ink note UI element 366. The ink note UI element 354 displays an image 356 of the ink note as entered on the underlying content, a text 358 of the digital ink, which includes the actual text of the digital ink, and one or more inferred or extracted keywords 360 and 362, that are keywords associated with the ink note. Furthermore, the UI element 354 includes a time element 354 that displays an indication about the time at which the ink note was generated, and document identification 364 that identifies the name of the document on which the note was taken. In some implementations, the document identification 364 is a link from which the document can be directly accessed.

Each ink note UI element may display contextual data generated as part of the ink note. As such the type of data displayed with the ink note is different for different ink notes. For example, the ink note UI element 366 displays the image 368 of the digital ink input and keywords 370 and 372 associated with the ink note and does not include a text element since the digital ink input for the ink note UI element 366 did not include text. In some implementations, selecting an ink note from the notes UI element 350 (e.g., clicking on a portion of the ink note UI element 354) results in opening the note in a note taking application. More contextual information associated with the ink note object may then be displayed with the ink note. In other implementations, clicking on a portion of an ink note UI element results in opening the underlying document on which the digital ink note was taken. In some implementations, when the underlying document is opened, the digital ink input is overlayed on the content such that it appears that the stored note was taken on the underlying content. In other implementations, the user is provided an option to select if they desired to display the ink notes on the document. In yet other implementations, the ink notes are displayed separately from the underlying content.

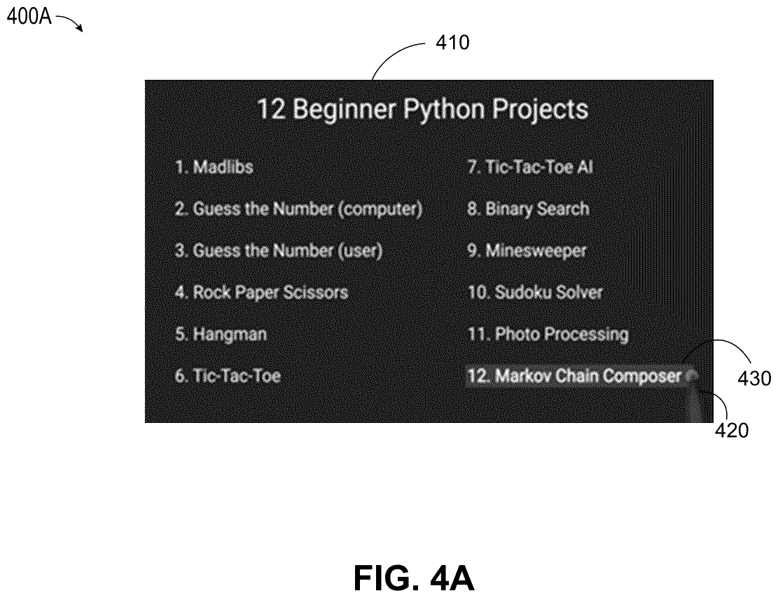

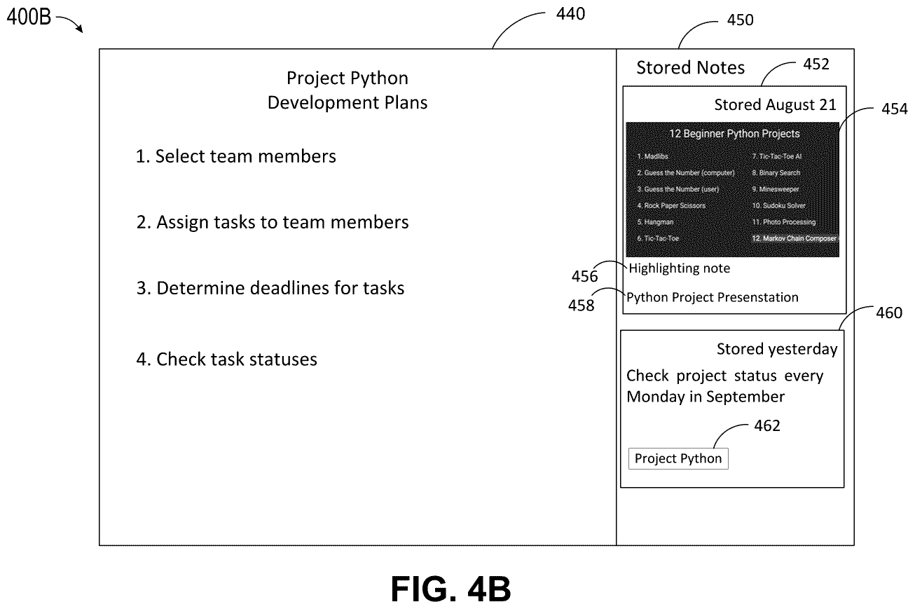

FIGS. 4A-4B depict alternative example UI screens for providing digital ink input and displaying previously generated ink notes. FIG. 4A depicts a UI screen 400A of a presentation application displaying a presentation slide 410 on which a digital ink input 430 is entered by utilizing a writing instrument 420. The digital ink input in the UI screen 400A is of a different type than the digital ink input provided in the UI screens of FIGS. 3A-3B. The digital ink input 430 is a highlighting of a portion of the underlying content of the presentation slide 410. Highlighting may be initiated by providing a specific type of gesture, selecting a specific button on the writing instrument 420 and/or making a specific stroke on the UI screen. In an example, a highlighting digital ink input is provided when users utilize their finger, mouse, and/or pen to highlight any content (e.g., text or non-text content) on the UI screen. For example, the user can pause a video that is playing or put the pen into a pen focus mode to initiate highlighting input. As the user highlights, the intelligent system captures the highlighting input as well as the underlying document or application context (e.g., slide title, URL on browser, document name, meeting name, meeting attendees, and the like), using both onscreen pixel detection and/or data about the user (e.g., current/active profile, current activity etc.).

After the user is done highlighting, a signal like pen lift off or specific pen button actions may indicate that the highlighting action is complete, which can lead to the content being automatically captured with the underlying content and the retrieved/inferred contextual data. An ink note object is then generated for the highlighting that stores the underlying content and the retrieved/inferred contextual data. The stored ink note object is then retrieved and displayed in a notes UI element 450, as depicted in the UI screen 400B of FIG. 4B. The UI element 450 is displayed when a determination is made that the stored ink note is relevant to the current content or current action being taken by the user. For example, when a document 440 is opened and displayed on the UI Screen 400B, the system may determine that the content of the document 440 is related to the same content on which the highlighting note was taken. This may be achieved by using natural language processing (NLP) and other ML models that analyze and perform topic modeling.

When it is determined that the current context (e.g., current document, event, and the like) is related to a previously stored ink note object, the UI element 450 is depicted to display the relevant ink notes. The UI element 450 includes a note UI element 452 for the highlighting note. The note UI element 452 includes an image 454 of the highlighting on the underlying content, an identification 456 that identifies the note as a highlighting note and a document identification 458 identifying the document on which the note was taken. The UI element 450 also includes a note UI element 460, the content of which have been identified as being related to the document 444. The note UI element 460 includes information about a note object. The information displayed in the note UI element 460 includes the text of the note and a keyword 462 identified as being associated with the ink note. The note UI element 460 does not include an image of the actual ink note. This may occur, when a determination is made that the actual ink note is not relevant or when the note was not taken over other content (e.g., the note is taken on the margin of a document and not on top of other content).

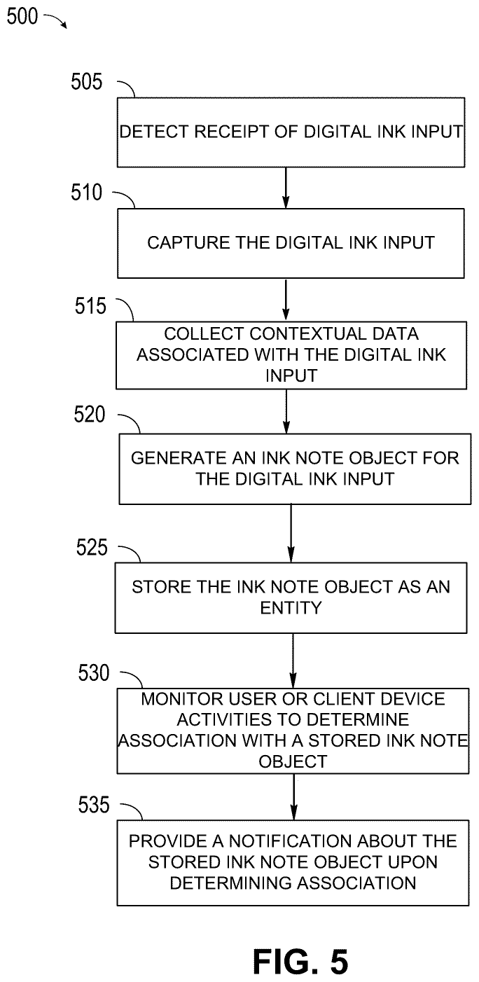

FIG. 5 is a flow diagram depicting an example method 500 for capturing and retrieving a digital ink note. In an example, one or more steps of method 500 may be performed by an application (e.g., application 124 of FIG. 1), pen digitizer (e.g., pen digitizer 126 of FIG. 1), and graphical operating system (e.g., graphical operating system 122 of FIG. 1). Other steps of method 500 may be performed by an ink capture and retrieval engine or service (e.g., ink capture and retrieval engine 128 or ink capture and retrieval service 132 of FIG. 1).

At 505, the method 500 may begin by detecting receipt of digital ink input on a UI screen. The UI screen is a UI screen of an application being executed on a client device and may be an ink-enabled or non-ink-enabled application. This may occur when the user begins entering digital ink input on the UI screen via a writing instrument. Once the digital ink input is detected, a determination may be made as to entering digital ink input is complete. This may be done by examining the digital ink input and/or by receiving a signal such a pen lift off for a predetermined amount of time. Once it is determined that digital ink input is complete, a determination may be made as to whether the entered digital ink input is an ink note. This may be done by examining the ink input and/or the underlying content and determining if the content of the ink input and/or underlying content indicates the presence of an ink note. When it is determined that digital ink input is for an ink note, the digital ink input is captured, at 510. Capturing the digital ink input may include capturing an image of the entered digital ink input and/or capturing an image of the underlying content.

Upon capturing the digital ink input, method 500 proceed to capture contextual data associated with the digital ink input, at 520. This may occur by collecting data about the underlying content (e.g., content of the document), about the document on which the underlying content is displayed, about the application displaying the underlying content, about an event associated with the digital ink input and/or about a page on which the digital ink input is entered. Once the data is collected, it is processed to extract or infer contextual data associated with the digital ink input. In some implementations, the digital ink input itself is processed (e.g., OCRed) to extract or infer additional contextual data.

After the contextual data has been collected, method 500 proceeds generate an ink note object for the digital ink input, at 520. The ink note object includes the digital ink input as well as the collected contextual data. The ink note object is stored as an entity, at 525. The entity is a separate entity from the underlying document or content, such that it can be accessed and viewed separately. After the ink note object is generated and stored, method 500 continuously monitors the activities of the user or activities performed on the client device to determine if there is an association between the stored ink note object and the current context, at 530. Once an association is detected, a notification is provided, at 535, about the stored ink note to notify the user of the existence of the stored ink note. The notification may be provided via a screen notification update, via one or more UI elements (e.g., pop-up menus) and/or via display of a side notification panel on the screen.

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 748 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram showing components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 816.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-7) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor; and
a memory in communication with the processor, the memory comprising executable instructions that, when executed by the processor, cause the data processing system to perform functions of:
detecting receipt of a digital ink input on a user interface (UI) screen, the UI screen being displayed by an application and the UI screen being associated with at least one of a document, a page or an event;
capturing the digital ink input;
collecting contextual data associated with the digital ink input, the contextual data being related to at least one of the document, the page, the event, and a user providing the digital ink input;
generating an ink note object for the digital ink input, the ink note object including the captured digital ink input and the contextual data; and
storing the ink note object as an entity that is separate from the document, the page and the event.

Item 2. The device of item 1, wherein the executable instructions, when executed by the
one or more processors, further cause the device to perform functions of:
monitoring current activities of the user to determine an association between the current activities and the stored ink note object; and
upon determining the association between the current activities and the stored ink note object, providing a notification to the user about the stored ink note object.

Item 3. The device of item 2, wherein the notification is displayed on the UI screen.

Item 4. The device of item 2, wherein the notification is provided via a UI pane.

Item 5. The device of item 4, wherein the UI pane displays at least one of the captured digital ink input and the collected contextual data.

Item 6. The device of item 2, wherein the association is an association between at least one of a currently open document, a current event, or a currently displayed page and the contextual data.

Item 7. The device of any preceding item, wherein the digital ink input includes at least one of a writing, drawing or highlighting.

Item 8. The device of any preceding item, wherein capturing the digital ink input includes capturing an image of the digital ink input and an image of an underlying content on which the digital ink input is entered.

Item 9. A method for automatically generating an ink note object comprising:
detecting digital ink input on a user interface (UI) screen, the digital ink input being received via a writing instrument, the UI screen being displayed by a non-ink enabled application and the UI screen being associated with at least one of a document, a page or an event;
capturing the digital ink input;
collecting contextual data associated with the digital ink input;
automatically generating an ink note object for the digital ink input, the ink note object including the captured digital ink input and the contextual data; and
storing the ink note object as an entity that is separate from the document, the page and the event.

Item 10. The method of item 9, further comprising:
upon storing the ink note object, monitoring activities of the user on a client device to identify an association between a current activity and the stored ink note object;
upon identifying the association between the current activity and the stored ink note object, providing a notification to the user about the stored ink note object.

Item 11. The method of item 10, wherein the notification provides access to the stored ink note object.

Item 12. The method of item 10, wherein the notification provides an image of the digital ink input.

Item 13. The method of item 10, wherein the notification provides a link for accessing the document, page or event.

Item 14. The method of any of items 9-13, wherein the digital ink input includes at least one of a writing, drawing or highlighting.

Item 15. The method of any of items 9-14, wherein the contextual data is stored as metadata for the ink note object.

Item 16. The method of any of items 9-15, wherein the ink note object is stored as a note into a note application.

Item 17. The method of any of items 9-16, further comprising upon generating the ink note object, providing a notification that seeks confirmation for storing the ink note object.

Item 18. A non-transitory computer readable medium on which are stored instructions that when executed cause a programmable device to perform functions of:
detecting receipt of a digital ink input on a user interface (UI) screen, the UI screen displayed content and the UI screen being associated with at least one of a document, a page or an event;
capturing the digital ink input;
collecting contextual data associated with the digital ink input, the contextual data being related to at least one of the content, the document, the page, the event, and a user providing the digital ink input;
generating an ink note object for the digital ink input, the ink note object including the captured digital ink input and the contextual data; and
storing the ink note object as an entity that is separate from the document, the underlying content, the page and the event.

Item 19. The non-transitory computer readable medium of item 18, wherein the ink note object is a separate object from the underlying content.

Item 20. The non-transitory computer readable medium of any of items 18 or 19, wherein the instructions further cause the programmable device to perform functions of:
monitoring current activities of the user to determine an association between the current activities and the stored ink note object; and
upon determining the association between the current activities and the stored ink note
object, providing a notification to the user about the stored ink note object.

In the foregoing detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A device comprising:
a processor; and
a memory in communication with the processor, the memory comprising executable instructions that, when executed by the processor, cause the device to perform functions of:
detecting receipt of a digital ink input on a user interface (UI) screen, the UI screen being displayed by an application and the UI screen being associated with at least one of a document, a page or an event;
capturing the digital ink input;
collecting contextual data associated with the digital ink input, the contextual data being related to at least one of the document, the page, the event, and a user providing the digital ink input;
generating an ink note object for the digital ink input, the ink note object including the captured digital ink input and the contextual data;
storing the ink note object as an entity that is separate from the document, the page and the event;
identifying, using a machine-learning model and based on current activities of the user, a context for which the stored ink note object should be retrieved; and
upon identifying the context, providing a notification to the user about the stored ink note object,
wherein identifying the context for which the stored ink note object should be retrieved includes determining the user has started a meeting with a same topic as a topic of a previous meeting for which an ink note object was previously stored, identifying the previously stored ink note object and retrieving the previously stored ink note object for display.

2. (canceled)

3. The device of claim 1, wherein the notification is displayed on the UI screen.

4. The device of claim 1, wherein the notification is provided via a UI pane.

5. The device of claim 4, wherein the UI pane displays at least one of the captured digital ink input and the collected contextual data.

6. The device of claim 1, wherein the context is an association between at least one of a currently open document, a current event, or a currently displayed page and the contextual data.

7. The device of claim 1, wherein the digital ink input includes at least one of a writing, drawing or highlighting.

8. The device of claim 1, wherein capturing the digital ink input includes capturing an image of the digital ink input and an image of an underlying content on which the digital ink input is entered.

9. A method for automatically generating an ink note object comprising:
detecting digital ink input on a user interface (UI) screen, the digital ink input being received via a writing instrument, the UI screen being displayed by a non-ink enabled application and the UI screen being associated with at least one of a document, a page or an event;
capturing the digital ink input;
collecting contextual data associated with the digital ink input;
automatically generating an ink note object for the digital ink input, the ink note object including the captured digital ink input and the contextual data;
storing the ink note object as an entity that is separate from the document, the page and the event;
identifying, using a machine-learning model and based on current activities of the user, a context for which the stored ink note object should be retrieved; and
upon identifying the context, providing a notification to the user about the stored ink note object;
wherein identifying the context for which the stored ink note object should be retrieved includes determining the user has started a meeting with a same topic as a topic of a previous meeting for which an ink note object was previously stored, identifying the previously stored ink note object and retrieving the previously stored ink note object for display.

10. (canceled)

11. The method of claim 9, wherein the notification provides access to the stored ink note object.

12. The method of claim 9, wherein the notification provides an image of the digital ink input.

13. The method of claim 9, wherein the notification provides a link for accessing the document, page or event.

14. The method of claim 9, wherein the digital ink input includes at least one of a writing, drawing or highlighting.

15. The method of claim 9, wherein the contextual data is stored as metadata for the ink note object.

16. The method of claim 9, wherein the ink note object is stored as a note into a note application.

17. The method of claim 9, further comprising upon generating the ink note object, providing a notification that seeks confirmation for storing the ink note object.

18. A non-transitory computer readable medium on which are stored instructions that when executed cause a programmable device to perform functions of:
detecting receipt of a digital ink input on a user interface (UI) screen, the UI screen displaying content and the UI screen being associated with at least one of a document, a page or an event;
capturing the digital ink input;
collecting contextual data associated with the digital ink input, the contextual data being related to at least one of the content, the document, the page, the event, and a user providing the digital ink input;
generating an ink note object for the digital ink input, the ink note object including the captured digital ink input and the contextual data;
storing the ink note object as an entity that is separate from the document, the content, the page and the event;
identifying, using a machine-learning model and based on current activities of the user, a context for which the stored ink note object should be retrieved; and
upon identifying the context, providing a notification to the user about the stored ink note object,
wherein identifying the context for which the stored ink note object should be retrieved includes determining the user has started a meeting with a same topic as a topic of a previous meeting for which an ink note object was previously stored, identifying the previously stored ink note object and retrieving the previously stored ink note object for display.

19. The non-transitory computer readable medium of claim 18, wherein the ink note object is a separate object from the content.

20. (canceled)

21. The device of claim 1, wherein identifying the context for which the stored ink note object should be retrieved includes identifying that the user has opened a document on which the user previously took a note, determining that a previously stored ink note object relates to the document on which the user previously took the note and retrieving the previously stored ink note object for display to the user.

22. The device of claim 1, wherein identifying the context for which the stored ink note object should be retrieved includes determining the user has started a meeting with at least one of a same group of participants as a previous meeting for which an ink note object was previously stored, identifying the previously stored ink note object and retrieving the previously stored ink note object for display.
